(19) United States
(12) Patent Application Publication
(10) Pub. No.: US 2020/0068881 A1
(43) Pub. Date: Mar. 5, 2020

(54) METHYL HYDROXYETHYL CELLULOSE AS A DRIFT CONTROL AGENT AND RAINFASTNESS AGENT

(71) Applicant: Akzo Nobel Chemicals International B.V., Amhem (NL)

(72) Inventors: Lei ZHANG, Chappaqua, NY (US); Turgut BATTAL, Stora Höga (SE); Rupak PAUL, St West Bengal (IN); Ulf SCHRÖDER, Lysekil (SE)

(21) Appl. No.: 16/466,438

(22) PCT Filed: Dec. 5, 2017
(86) PCT No.: PCT/EP2017/081458

§ 371 Date: Jun. 4, 2019

Related U.S. Application Data
(60) Provisional application No. 62/431,511, filed on Dec. 8, 2016.

(30) Foreign Application Priority Data
Jan. 6, 2017 (EP) 17150526.6

(51) Int. Cl. A01N 25/06; A01N 57/20; A01N 37/40; A01N 39/04

(52) U.S. Cl. CPC A01N 25/06; A01N 57/20; C08L 1/284; A01N 39/04; A01N 37/40

(57) ABSTRACT

The present invention is directed to a method of spraying an aqueous solution of an agrochemical comprising at least one cellulose ether, wherein the cellulose ether is a methyl hydroxyethyl cellulose (MHEC) polymer. The present invention is also directed to a method for reducing spray drift during the spraying of an aqueous solution. The methods comprise: providing a MHEC polymer; combining the MHEC polymer with at least one agricultural chemical and water to obtain an aqueous solution; and spraying the aqueous solution. Further, the present invention is also directed to a method for providing good resistance to rain wash-off of an agricultural chemical which was deposited onto a surface by spraying. This method comprises: providing a MHEC polymer; combining the MHEC polymer with at least one agricultural chemical and water to obtain an aqueous solution; spraying the aqueous solution onto a surface; and evaporating at least part of the water of the droplets of the aqueous solution which were deposited onto the surface by said spraying.

### FIELD OF THE INVENTION

The present invention relates to a new way of reducing spray drift during the spraying of an aqueous solution of an agrochemical and obtaining a deposit of said agrochemical which resists rain wash-off.

### BACKGROUND OF INVENTION

The fine droplets in the spray mist generated during spraying of an agrochemical, particularly pesticide formulations, can travel with the wind, hence exposing humans, wildlife, and the environment to residues that may have health and environmental effects and may cause property damage.

Various methods have been proposed in an attempt to reduce the amount of drifting of fine droplets during spraying of agrochemicals and their solutions. One method is to modify the nozzle design so as to allow bigger spray droplets when the liquid passes through the nozzle. Another method is to use a drift control chemical agent. Various drift control agents are known, including polymers and surfactants. One useful polymer class is high molecular weight water-soluble polysaccharides, such as derivatives of guar gum, xanthan gum, and certain cellulose ethers. It has been generally accepted that the mechanism of drift control by such polymers is that these polymers increase the elongational or kinematic viscosity of the diluted aqueous solution. The increased viscosity usually results in increased droplet size and reduced fines. Over the years, researchers have found that the optimum spray pattern has a droplet size distribution in the mist of between 150-400 μm.

Cellulose ethers such as hydroxyethyl cellulose (HEC), ethyl hydroxyethyl cellulose (EHEC), hydroxylpropyl cellulose (HPC), hydroxybutyl methylcellulose (HBMC), hydroxypropyl methylcellulose (HPMC), methyl ethyl hydroxyethyl cellulose (MEHEC), and hydrophobically modified ethyl hydroxyethyl cellulose (HMEHEC) are known modifying agents, with MEHEC polymers being preferred, particularly MEHEC with a DSmethyl >0.3 and a DSethyl >0.2, as in WO 2014/139975. However, the use of these conventional cellulose ethers were found to result in too much spray drift.

WO 2010/094670 discloses how to dip fruit in natamycin compositions that are thickened with a large amount of MHEC. The thickened solutions were not shown to have reduced spray drift while providing rain-fastness.

There is a need for agrochemical formulations with an even further reduced amount of drift, with at least a similar rainfastness of the deposited agrochemical.

### SUMMARY OF THE INVENTION

After extensive research it has been found that another nonionic cellulose ether, quite unexpectedly, outperforms the conventional cellulose ethers in the control of spray drift. More specifically, methyl hydroxyethyl cellulose (MHEC), a known cellulose ether that is traditionally used in cement-based mortars for water retention, was found to give a desired and unexpected lowering of the amount of very fine droplets in a spray (the droplets <150 μm). The very fine droplets are the ones causing the undesired spray drift. Accordingly, the use of MHEC in agrochemical compositions allows for a further reduction of the amount of spray drift, which is beneficial to the environment and results in a more economical use of the agrochemical. Suitable are MHECs with an average molecular weight that is such that the MHEC polymer has a viscosity of greater than 2,000, measured at 1% w/w concentration and using spindle number 3, and less than 10,000, measured at 0.5% w/w concentration using spindle number 2, both in water at pH=7 using a Brookfield viscometer type VI at 12 rpm at 20° C. in a container with diameter of 6.5 cm, which is the default method used herein. It was surprisingly found that the deposited agrochemical, when using these MHECs, showed a rain-fastness of the deposited agrochemical which is better than the rainfastness of the same chemical when deposited using the same spray composition without MHEC.

There is no upper limit for the molecular weight of the MHEC that is used in accordance with the invention. With a higher molecular weight typically less MHEC is needed in a spray solution. However, higher molecular weight product is more susceptible to degradation, i.e. by shear forces, and may be harder to dissolve. In an embodiment the MHEC upper molecular weight is such that a 0.1% w/w solution in demineralized water at 20° C. has a viscosity of less than 500, 300, or 250 mPas.

To date, there has been no teaching or disclosure on the use of MHEC as a drift control agent that would result in good rain-fastness after spraying. Accordingly, the present invention is directed to an agricultural composition comprising at least one agricultural chemical and at least one cellulose ether, wherein the cellulose ether is a nonionic MHEC polymer. The present invention is also directed to a method for reducing spray drift during the spraying of an aqueous solution of an agrochemical which method comprises: providing a nonionic MHEC polymer; combining the MHEC polymer with at least one agricultural chemical and water to obtain the aqueous solution; and spraying the aqueous solution. Further, the present invention is also directed to such a method wherein the sprayed solution leaves the agrochemical as a deposit on the substrate, with said deposit having a resistance to rain wash-off that is better than that of deposits obtained by spraying the same solution without MHEC. In one embodiment the invention therefor relates to the use of a MHEC polymer in an aqueous solution comprising an agricultural chemical, selected from one or more pesticides, growth regulators, micronutrients, fertilizers, and combinations thereof, to improve the rain-fastness of the deposited agricultural chemical after spraying the solution on a substrate and vaporization of the water.

### DETAILED DESCRIPTION OF THE INVENTION

The present invention is directed in one embodiment to a method for reducing spray drift during the spraying of an aqueous solution of an agrochemical. The method comprises: providing a nonionic MHEC polymer; combining the MHEC polymer with at least one agricultural chemical and water to obtain the aqueous solution; and spraying the aqueous solution. Further, the present invention is also directed to a method to increase the resistance of the deposited agrochemical to rain wash-off after spraying the aqueous solution onto a surface. The method comprises the steps of i) providing a nonionic MHEC polymer; ii) combining the MHEC polymer with at least one agricultural chemical and water to obtain the aqueous solution; iii) spraying the aqueous agricultural chemical solution onto a substrate, and iv) evaporating at least part of the water from the solution that was sprayed onto said substrate to form a deposit. In another embodiment, the invention relates to the use of a MHEC polymer to reduce the formation of droplets with a volume of <150 μm when a solution is sprayed, by dissolving said MHEC in said solution. Such a use is specifically of interest if the solution is an aqueous solution of an agrochemical.

In an aspect of the invention, the MHEC polymer has a degree of substitution of methyl groups on the glucose units of the cellulose (DS_{M}) of greater than 0.1, in one embodiment greater than 0.2 or 0.3 or 0.4; in another embodiment, greater than 0.5, up to a value of 1.5, 2.0, 2.5, or the theoretical maximum of 3.0. In another aspect of the invention, the MHEC polymer has an average molar substitution of ethylene oxide group on the glucose units of the cellulose (MS_{EO}) of greater than 0.1; in one embodiment greater than 0.2, 0.3, 0.5, or 1.0, up to 1.4, or 1.8, or up to the theoretical maximum of 2.0. It is noted that the determination of the degree of substitution and average molar substitution is well known in the art and one skilled in the art is familiar therewith. Suitably the substitution of the cellulose is determined after cleaving the methyl and hydroxyethyl substituents of the cellulose ether with HI or HBr, with the resulting MeI and EtI, or MeBr and Br—(CH₂)₂—Br, respectively, analyzed for by GC or GC-MS. For better accuracy, the cleavage results of HI and HBr are compared.

In an embodiment the ratio between DS_{M} and MS_{EO} is from 0.05 or 0.1 up to 25 or 20. MHEC with such a degree of substitution was found to provide the desired reduction in spray drift while giving the desired rain fastness.

In another aspect of the invention, the MHEC polymer has a viscosity of greater than 3,000, 4000, 4,500, 5,000 5,500, 6,000, or 6,500 mPas measured at 1% w/w concentration in water at pH=7 using a Brookfield viscometer type VI at 12 rpm using spindle number 3 at 20° C. in a container with diameter of 6.5 cm. In another aspect of the invention, the MHEC polymer has a viscosity of less to than 9,000, 8000, 7,500, 7,000 or 6,500 mPas measured at 0.5% w/w concentration in water at pH=7 using a Brookfield viscometer type VI at 12 rpm using spindle number 2 at 20° C. in a container with diameter of 6.5 cm. MHEC with such a degree of substitution was found to easily dissolve, provide the desired reduction in spray drift while giving the desired rain fastness.

The exact mechanism how the MHEC polymers reduce spray drift is unknown. It was found that viscosity of the solution itself is not decisive. More specifically, the shear viscosity (thickening of the solution) was found to be unable to explain the differences in spray drift. Furthermore, drift was also found to be influenced by parameters such as static surface tension, dynamic surface tension, and elongational viscosity.

In one embodiment, the agricultural composition or spraying solution comprises 0.01-5.0 wt % of the MHEC polymer and more than 50 wt % of water. In another embodiment, the agricultural composition or spraying solution comprises 0.02-2.0 wt % of the MHEC polymer; in yet another embodiment, 0.025-1.0 wt % of the MHEC polymer, in yet another embodiment, 0.03-0.75 wt % of the MHEC polymer. In yet another embodiment a spraying solution is used which comprises 0.03-0.19 wt % of the MHEC polymer, optionally the MHEC polymer has a viscosity greater than 5,000 mPas at 1% concentration. In a spraying solution, the amount of MHEC can be increased in order to reduce the amounts of fines in the spray to the desired level. Typically the maximum amount of MHEC to use is determined by economics.

In another embodiment, the agricultural composition or spraying solution comprises more than 80 wt % of water; in yet another embodiment, more than 95 wt % of water, in yet another embodiment, more than 98% of water. It is noted that at these low concentrations of MHEC, the spraying solutions are not thickened. “Not thickened” means that the viscosity is not more than 25% more than the viscosity of the same formulation without the MHEC. In another to embodiment the viscosity, of non-thickened compositions of the invention, is not more than 20%, 15, 12.5, 10, or 7.5% more than the viscosity of the same formulation without the MHEC.

It should be appreciated that the various aspects and embodiments of the detailed description as disclosed herein are illustrative of the specific ways to make and use the invention and do not limit the scope of invention when taken into consideration with the claims and the detailed description. It will also be appreciated that features from different aspects and embodiments of the invention may be combined with features from different aspects and embodiments of the invention. The term “consisting” wherever used herein also embraces “consisting substantially”, but may optionally be limited to its strict meaning of “consisting entirely”. Further, throughout the description and claims of this specification, the words “comprise” and “contain” and variations of the words, for example “comprising” and “comprises”, mean “including but not limited to”, and do not exclude other moieties, additives, components, integers or steps. Moreover the singular encompasses the plural unless the context otherwise requires: in particular, where the indefinite article is used, the specification is to be understood as contemplating plurality as well as singularity, unless the context requires otherwise. Where upper and lower limits are quoted for a property, for example for the concentration of the MHEC, then a range of values defined by a combination of any of the upper limits with any of the lower limits is also implied. Amounts, unless defined differently, are in weight percent (wt %). “Substantially free of” a certain component for the purpose of the present invention means that the content of such certain component in the composition is less than 10 wt %, more specifically less than 5 wt %, even more specifically less than 1 wt %, in particular less 0.5 wt %, and in one embodiment less than 0.1 wt %.

The MHEC polymer may be used in a powder form. The MHEC polymer may also contain certain process aids such as an anti-caking agent, a wetting agent, and/or a flowing aid. Alternatively, the MHEC polymer may be used in a liquid to form, for example by suspending or dissolving it into a polar medium. Suitably they are supplied as a solution in a polar medium comprising one or more polar media and optional further additives, such as defoamers and other drift control agents, including guar gum. Polar media comprise water, alcohols, diols, including glycols and hydroxyl (poly)ether derivatives thereof, triols, such as glycerol and trimethylolpropane and hydroxyl (poly)ether derivatives thereof, polyols, including saccharides and hydroxyl (poly)ether derivatives thereof. Suitably the polar medium comprises water. Suitably it is a combination of water and one or more of the other polar media. When supplied in a concentrated solution, which may be preferred for dilution by a farmer, the concentration of the MHEC in the solution is suitably from 0.2, 0.5, 1, 5, 10, or 11 wt % up to 13, 15, 20, 25, 30, 35, or 40 wt %, where the lower limit is mostly dictated by the economics of transporting and handling of the solution and where the upper limit is typically dictated by maximum solubility and the maximum viscosity of the solution which can be handled, and ease of accurate dilution to the level needed by the farmer.

In one aspect of the invention, the claimed composition is substantially free of aluminosilicate mineral, more specifically, foamed aluminosilicate mineral. In another aspect of the invention, the composition is not in a form of or is substantially free of granules with pores.

In an embodiment the composition of the invention is not a paint composition.

In an embodiment the agricultural chemical is not a polyene antifungal agent. In an embodiment the agricultural chemical is not a polyene macrolide antimycotic-based fungicide. In an embodiment the agricultural chemical is not natamycin.

The agricultural chemical according to the present invention may be a chemical selected from one or more pesticides, growth regulators, micronutrients, fertilizers, and/or combinations thereof. In an embodiment the agrochemical is fully water-soluble in order to allow spraying with reduced nozzle blocking. In an to embodiment they are provided as an emulsion in an aqueous medium.

Pesticides that can be used include herbicides, insecticides and/or fungicides known in the art. More specifically, the insecticide may be selected from the group consisting of chlofenapyr, pyrethrin, piperonyl butoxide and mixtures thereof. As to the herbicide, it may be selected from the group consisting of glyphosate, 2,4-D, sulfonyl urea, dicamba, and mixtures thereof; and as to the fungicide, it may be selected from the group consisting of sulfur, dithiocarbamates and their derivatives, nitro derivatives, heterocyclic substances, strobilurins, anilinopyrimidines, and mixtures thereof. In an embodiment the agricultural chemical is the fungicide Captan.

The agricultural composition according to the present invention may further comprise at least one surfactant. Examples of surfactants suitable for use in the present invention include, but are not limited to, nonionic surfactants such as alcohol alkoxylates, alkylphenol alkoxylates, fatty acid alkoxylates, alkyl polyglucosides, and alkoxylated methylated seed oils; anionic surfactants such as alkyl sulfates, alkyl ethersulfates, sulfonates including alkyl benzene sulfonates, and phosphate esters; and nitrogen-containing surfactants. Suitable nitrogen-containing surfactants are neutral, amphoteric, or cationic, Suitable neutral nitrogen-containing surfactants are alkanol amides and their alkoxylates, alkylamines and their alkoxylates, amidoamines, such as those derived from a fatty acid and an amine selected from ethylene diamine, diethylenetriamine, triethylenetetramine, and alkylated derivatives thereof, such as N,N-dimethylaminopropylamine, and alkoxylated amidoamines. Suitable cationic nitrogen-containing surfactants are neutral nitrogen-containing surfactants which have been quaternized. Suitable amphoteric nitrogen-containing surfactants are betaines, including quaternary alkyl dimethyl betaines, and amine oxides, such as alkyl dimethyl amine oxide, alkoxylated alkylamine oxide, and ethylene diamines oxides. More particularly, the surfactant may be selected from the group consisting of a dialkyl (C12-C22) quaternary surfactant, an alkyl (C12-C22) dimethylbetaine, an alkyl (C12-C22) dimethylamine oxide, an ethoxylated alkyl (C12-C22) amine oxide with less than 4EO units, an to ethoxylated alkyl (C12-C22) quaternary surfactant, and an alcohol ethoxylate with less than 10 EO units, and mixtures thereof.

The present invention is directed to a method for reducing spray drift during the spraying of an aqueous solution. In one aspect of the invention, the volume of fine droplets of <150 μm, when analyzed using a Sympatec Helos/R laser diffraction particle size analyzer fitted with the R6 lens, is reduced by >10% during the spraying of the aqueous solution; in another aspect of the invention, by >15%; in yet another aspect of the invention, by >20%; in one other aspect of the invention, by >30%, when compared to other spray drift control agents, i.e. methyl ethyl hydroxyethyl cellulose (MEHEC) with the same molecular weight.

The present invention is also directed to a method for depositing an agrochemical on a surface by spraying to obtain a deposit that is resistant to rain wash-off. The resistance to rain wash-off (rain-fastness) should be the same or better as the rain-fastness of conventional deposits i.e. those wherein methyl ethyl hydroxyethyl cellulose (MEHEC) with the same molecular weight is used instead of the MHEC. The method comprises spraying the aqueous agrochemical solution comprising a nonionic MHEC polymer onto a substrate and evaporation of at least part of the water to form a deposit. The substrate may be the surface of a plant, e.g., a leaf surface, or a field.

It is noted that “MHEC” as used herein refers to methyl hydroxyethyl cellulose, as is commonly known in the art, and typically produced by reacting alkali-cellulose, such as produced for example by reacting one or more alkali-metal hydroxides with a cellulose source or combination of cellulose sources, with methyl chloride and ethylene oxide in one or more reaction steps in any sequence, whereby the methyl chloride and/or the ethylene oxide may be used in one or more reaction steps. Suitably such reactions are performed in an aqueous medium, which can contain other water-miscible solvents, such as methanol, ethanol, propanol (any isomer), and the like. Advantageously, an to aqueous medium is used that comprises one or more of the components used in the process to spray agrochemicals, since this means that less rigorous purification of the MHEC may be acceptable.

The MHEC may contain other additives as commonly used in the art. For example, it may contain other salts to influence its dissolution speed in water.

Also, it may contain temporary cross-links, for example after reaction with glyoxal, which hydrolyse upon dissolution in an aqueous medium. Also it can contain additives to ensure easy handling of the dry product, products improving storage stability, and further agents including one or more antimicrobial agents, sticking agent, surfactants, preservatives, spreading agents, antioxidants, anti-foam-forming agents, wetting agents, fillers, spray oils, flow additives, and combinations thereof, provided that such products do not adversely affect the spraying of solutions comprising the MHEC.

The present invention will now be illustrated by the following non-limiting examples.

### EXAMPLES

Throughout the examples, the droplets refer to the droplets in the spray mist and the concentration is in wt % unless specified differently.

The comparative polymer used is Adsee® DR-22, which a conventional MEHEC polymer available from AkzoNobel.

The MHEC polymers that were used were Walocel® MKX 60000 PF1 and MKX 70000 PP01 from The Dow Chemical Company.

### Examples 1-2 and Comparative Examples A-B

The performance of two MHEC polymers of the invention was compared to the performance of a conventional MEHEC polymer for spraying aqueous solutions comprising 0.042 percent by weight of the solution (% w/w) of the polymer in deionized water. More specifically, the effect of the different cellulose ether polymers on drift control performance was analyzed by determining the spray to droplet distribution, which measurement was performed using a Sympatec® Helos/R laser diffraction particle size analyzer fitted with the R6 lens that is capable of detecting droplets in air from 0.5 μm to 1750 μm. The “% volume <150 μm” is a value describing the percent volume of droplets whose size is below 150 μm.

The spray nozzle used in the experiment was a TEEJET® 8002 flat fan nozzle, available from Teejet Technologies. The studied aqueous solution is ejected through the nozzle under the indicated pressure N₂. The design of this type of nozzle is able to produce a lot of fine droplets. For water, in this spray setup, the typical % volume <150 μm is about 50-55%. Some diluted aqueous pesticide solutions produced more than 48-53% droplets with size <150 μm (measured with Sympatec Helos/R mentioned above). A good drift control agent is defined as one that can reduce the % volume <150 μm by >30%. It is understood that the higher the percentage (e.g., >30%, >40%, >50%), the better the drift control agent.

A number of formulations were prepared and sprayed both with and without cellulose-based drift control agents. During the sample preparation, the different cellulose ether polymers were dissolved in the water, then the prepared solutions were sprayed at the conditions described above.

The results are shown in Table 1.

TABLE 1
The drift control performance of 0.042% w/w drift control agents in
distilled water.

| | | % <150 μm | | |
|---|---|---|---|---|
| Example | Product | 2.1 barg | 2.8 barg | |
| Water pressure | | (30 psi) | (40 psi) | 4.1 barg (60 psi) |
| A | Water/blank | 34.4 | 48.6 | 58.9 |
| B | DR-22 | 17.3 | 37.5 | 42.9 |
| 1 | MKX 60000 PF1 | 14.2 | 29.1 | 38.7 |
| 2 | MKX 70000 PP01 | 13.5 | 28.1 | 35.9 |

The results show that the cellulose ether polymers of the invention reduce the volume of fine droplets more than a conventional MEHEC polymer at typical pressures.

### Examples 3-4 and Comparative Examples C-D

The previous examples 1-B were repeated using a water pressure of 2.8 barg to (40 psi) but a different nozzle. The TJ8002 nozzle was replaced with an AIXR110015 wide angle (110°) flat spray nozzle from the same supplier.

TABLE 2
The drift control performance of 0.042% w/w drift control agents in
distilled water using an AIXR110015 nozzle.

| Example | Product | % <150 μm |
|---|---|---|
| C | Water/blank | 62.0 |
| D | DR-22 | 42.0 |
| 3 | MKX 60000 PF1 | 32.9 |
| 4 | MKX 70000 PP01 | 30.6 |

Again, the cellulose ether polymers of the invention reduced the volume of fine droplets more than the conventional MEHEC polymer.

### Examples 5-6 and Comparative Examples E-F

The examples 1-B were repeated using a water pressure of 2.8 barg (40 psi), except that hard water (1000 mg/L CaCO₃) was used instead of distilled water. The results are shown in Table 3.

TABLE 3
The drift control performance of 0.042% w/w drift control agents in
hard water.

| Example | Product | % <150 μm |
|---|---|---|
| E | Water/blank | 49.4 |
| F | DR-22 | 38.3 |
| 5 | MKX 60000 PF1 | 32.3 |
| 6 | MKX 70000 PP01 | 23.3 |

Also in this system the cellulose ether polymers reduced the volume of fine droplets more than the conventional MEHEC polymer.

### Examples 7-8 and Comparative Examples G-H

It is well known that pesticide formulations can have significant impact on the performance of drift control agents due to the presence of surfactants in the formulation. To examine the effect of pesticide formulations, examples 1-B were repeated using a water pressure of 2.8 barg (40 psi) and dissolution of the polymers in a glyphosate formulation (Roundup® WeatherMax). WeatherMax contains K-glyphosate and some surfactants.

A 2% ae glyphosate WeatherMax solution in demineralized water was prepared and the polymers were dissolved therein. The results are shown in Table 4.

TABLE 4
Drift control performance of MHEC 1 in Roundup
WeatherMax solution.

| Example | Product | % <150 μm |
|---|---|---|
| G | 2% ae glyphosate/blank | 57.7 |
| H | DR-22 | 29.8 |
| 7 | MKX 60000 PF1 | 28.2 |
| 8 | MKX 70000 PP01 | 15.3 |

Also in this system the cellulose ether polymers reduced the volume of fine droplets more than the conventional MEHEC polymer.

### Examples 9, 10, and I

Rain-fastness is another desired attribute for agrochemical application. The polymers and a water-soluble dye, Tartrazine, were dissolved in demineralized water, each in a concentration of 0.048% w/w. Drops of the mixture are deposited onto a Parafilm® serving as a model hydrophobic plant leaf. The Parafilm is mounted over a Petri dish. The deposited drops are then left to dry at room temperature. After the drops have dried up, the Petri dish covered by the Parafilm with dried drops is placed 50 cm under the bottom of a “rain source” for 15 seconds. The “rain source” is created by flowing 400 g water to rapidly from a vertically oriented cylindrical vessel with a diameter of 10 cm containing 169 holes, each with a diameter of 1 mm, that are equally distributed over the bottom of said vessel. The appearances of the dried deposited drops are compared before and after the simulated rain. Rain-fastness is determined by visual inspection of the droplets by the naked eye.

The results as in the table.

| Example | Product | Rainfastness |
|---|---|---|
| I | DR-22 | All retained |
| 9 | MKX 60000 PF1 | All retained |
| 10 | MKX 70000 PP01 | All retained |

show that all the drops were retained on the Parafilm, showing good rainfastness for all polymers.

In the above examples it was also observed whether or not the drops, before drying, were running off the Parafilm when the Parafilm was brought to an incline with an angle of 60° from level. For all polymers, all of the drops stayed on the Parafilm, showing that the droplets have good deposition on this substitute leaf-surface.

1. A method for reducing spray drift during the spraying of an aqueous solution, the method comprising:
combining methyl hydroxyethyl cellulose (MHEC) with at least one agricultural chemical selected from one or more pesticides, growth regulators, micronutrients, fertilizers, and combinations thereof, and water to obtain an aqueous solution; and
spraying the aqueous solution,
wherein the MHEC polymer has a degree of substitution of greater than 0.1 for methyl and a molar degree of substitution of greater than 0.1 for ethylene oxide and wherein the MHEC polymer has a viscosity of greater than 5,000 mPas measured at 1% in water with pH=7 using a Brookfield viscometer type LV at 12 rpm using spindle number 3 at 20 degrees C. in a container with a diameter of 6.5 cm.

2. The method of claim 1 wherein the MHEC polymer has an average molar of substitution of ethylene oxide of greater than 0.5.

3. The method of claim 1 wherein the agricultural composition comprises 0.01-5.0% w/w of the MHEC polymer and more than 50% w/w of water.

4. The method of claim 1 wherein the degree of substitution and amount of MHEC is adapted such that the volume of fine droplets of <150 μm in the spray is reduced by >30% during spraying compared to the same solution without MHEC.

5. The method of claim 4 wherein the volume of fine droplets of <150 μm is reduced by >40% during spraying compared to the same solution without MHEC.

6. The method of claim 1 wherein the agricultural chemical is a pesticide, preferably a herbicide, and/or insecticide.

7. The method of claim 6 wherein the pesticide is a herbicide, preferably glyphosate, 2,4-D, and/or dicamba.

8. A method for increasing resistance to rain wash-off of an agrochemical deposited on a substrate by means of spraying an aqueous solution of claim 1 on said substrate and wherein at least part of the water of the droplets, deposited on said substrate by said spraying, is evaporated.

9. Use of a MHEC polymer in an aqueous solution comprising an agricultural chemical, selected from one or more pesticides, growth regulators, micronutrients, fertilizers, and combinations thereof, to reduce the spray drift during the spraying of said solution.

10. Use of a MHEC polymer in an aqueous solution comprising an agricultural chemical, selected from one or more pesticides, growth regulators, micronutrients, fertilizers, and combinations thereof, to improve the rain-fastness of the deposited agricultural chemical after spraying the solution on a substrate and vaporization of the water.

11. An aqueous spray-solution comprising more than 50% w/w of water, 0.01-5.0% w/w of MHEC as defined in claim 1, and at least one agricultural chemical as defined in claim 1.

12. Spraying an aqueous spray-solution of claim 11 onto plants.

13. A deposited blend comprising an agrochemical and MHEC obtained by the method of claim 8.

14. (canceled)
